(19) United States
(12) Patent Application Publication
(10) Pub. No.: US 2018/0223228 A1
(43) Pub. Date: Aug. 9, 2018

(54) RESTORATION SYSTEM AND METHOD

(71) Applicant: Jeff Wakelam, Nampa, ID (US)

(72) Inventor: Jeff Wakelam, Nampa, ID (US)

(21) Appl. No.: 15/892,272

(22) Filed: Feb. 8, 2018

Related U.S. Application Data
(60) Provisional application No. 62/456,207, filed on Feb. 8, 2017.

(51) Int. Cl. C11D 11/00; B05D 1/02; B05D 3/00; E01C 11/00; C11D 7/26; C11D 7/04

(52) U.S. Cl. CPC C11D 11/0052; B05D 1/02; C11D 7/04; E01C 11/005; C11D 7/265; B05D 3/007

(57) ABSTRACT

A restoration system which is used to restore brick, glass, concrete, metal, plexiglass, and stone to their original color and preserve the materials. The restoration system includes a treatment composition overlay including a first-dry-part, a second-dry-part, a first-liquid-part, and a second-liquid-part. The first-dry-part is an acrylic based dry polymer. The second-dry-part is an acrylic based dry hardener. The first-liquid-part includes polymeric resin, water, acrylic polymer, and sodium. The second-liquid-part includes acrylic resin, water acrylic polymer, aqueous ammonia, and additives. The first-dry-part, the second-dry-part, the first-liquid-part, and the second-liquid-part are configured to be mixed to create a treatment composition overlay for restoring and preserving at least one surface.

### CROSS REFERENCE TO RELATED APPLICATION

The present application is related to and claims priority to U.S. Provisional Patent Application No. 62/456,207 filed Feb. 8, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of restoration means and more specifically relates to stain removal and color restoration methods and means.

### 2. Description of Related Art

Stone is a porous material which is susceptible to staining. Granite and marble are frequently used in residential construction of bathrooms and kitchens and are susceptible to a variety of stains. A porous stone becomes stained when a solution containing a solute penetrates its surface and then evaporates leaving the solid solute behind within the stone. This happens with various other porous materials as well. Brick, glass, metal, and stone can be stained by variety of things, such as water. This can detract from the integrity and appearance of the material. It can be difficult to restore the color and preserve the materials. Many homeowners and business owners feels as though they are not able to protect their investment when their siding, walkways, roofs, patios, counters, and other surfaces are damaged by the elements. An effective solution is needed for covering and protecting surfaces.

U.S. Pat. No. 7,375,069 to Nazim Z. Muradov relates to a method for masking and removing stains from rugged solid surface. The described method for masking and removing stains from rugged solid surface includes methods, compositions and kits for masking and subsequent removal of oil, grease, rust and other stains from a variety of rough solid surfaces, including, but not limited to stone, concrete, asphalt, stucco brick, and ceramic. The methods include coating the stains with an opaque or translucent thin film of a composition that makes the stain practically indistinguishable against the background, exposing the coated stain to the elements, such as, sunlight, air, moisture, resulting in spontaneous transformation, degradation and subsequent removal of the stains from the solid surfaces. The compositions include a photocatalyst by itself or the photocatalyst combined with at least one of, a sensitizer, a dopant, a mediator, a co-reagent, a pigment and a binder. The role of a photocatalyst is to produce highly reactive species or radicals and initiate the degradation of a stain upon exposure to elements, such as, sunlight, air and ambient humidity. Artificial light sources can be used instead of sunlight.

### BRIEF SUMMARY OF THE INVENTION

In view of the foregoing disadvantages inherent in the known restoration means art, the present disclosure provides a novel restoration system and method. The general purpose of the present disclosure, which will be described subsequently in greater detail, is to provide a restoration system to restore brick, glass, concrete, metal, plexiglass, and stone to their original color and preserve the materials.

A restoration system is disclosed herein. The restoration system includes a treatment composition overlay including at least a first-dry-part, at least a second-dry-part, at least a first-liquid-part, and at least a second-liquid-part. The overlay composition comprises the first-dry-part, the second-dry-part, the first-liquid-part, and the second-liquid-part as an adjustable admixture. The first-dry-part preferably comprises an acrylic based dry polymer. The second-dry-part preferably comprises an acrylic based dry hardener. The first-liquid-part preferably comprises polymeric resin, water, acrylic polymer, and sodium. The second-liquid-part preferably comprises acrylic resin, water acrylic polymer, aqueous ammonia, and additives. The first-dry-part, the second-dry-part, the first-liquid-part, and the second-liquid-part are configured to be mixed to create a treatment composition overlay for restoring and preserving at least one surface.

A first method of using restoration system to create a dry-overlay is also disclosed herein. The method of using the restoration system may comprise the steps of: applying a second-liquid-part to at least one surface; drying the second-liquid-part on the at least one surface; applying a first-liquid-part; while it's still wet, broadcasting dry aggregate evenly into the first-liquid-part; drying; and spraying the second-liquid-part.

A second method of using restoration system to create a wet-overlay is also disclosed herein. The method of using the restoration system may comprise the steps of: spraying at least one surface with a second-liquid-part; mixing a first-dry-part and a second-dry-part into preferably 6 parts aggregate creating a mixture; adding a first-liquid-part to the mixture; mixing the mixture to a desired consistency; and applying the mixture to the at least one surface. The mixture may be thinned with water to extend dry times based on desired application and ambient conditions.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a restoration system and method, constructed and operative according to the teachings of the present disclosure.

FIG. 1 is a perspective view of the restoration system according to an embodiment of the disclosure.

FIG. 2 is a perspective view of the restoration system of FIG. 1, according to an embodiment of the present disclosure.

FIG. 3 is a perspective view of the restoration system of FIG. 1, according to an embodiment of the present disclosure.

FIG. 4 is a flow diagram illustrating a method of use for restoration system, according to an embodiment of the present disclosure.

FIG. 5 is a flow diagram illustrating another method of use for restoration system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a restoration means and more particularly to a restoration system and method as used to improve coverage and protection of surfaces and stain removal and color restoration methods and means.

Generally, the present invention provides a restoration system to restore brick, glass, concrete, metal, plexiglass, and stone (and other suitable materials) to their original color and preserve the materials. It enhances the exterior of solid surface counters, fiberglass RVs, boats, siding, and more. The overlay process can be used on practically any building material. The following materials are examples, but the process is not limited to; block, brick, cultured stone, concrete, counters, fiberglass, flooring, gravel, laminate, masonry, plexiglass, siding, steel, truck bed liner, under carriage coating, wood, etc. It enables gravel or loose stones to be bonded together to create a permeable, walkable surface. This allows damaged roofs to be repaired without re-roofing, and enables damaged or stained concrete to be over laid using this process.

The present invention expands and contracts with freeze/thaw cycles, is waterproof, and is excellent for sealing cracks or voids. The overlay process pre-treats the concrete, overlays it with the desired color aggregate, then it is re-treated twice. There's no bubbling with the overlay process. Cracks or imperfections can be covered and strengthened. The product resists stains, U.V., and is waterproof. The product is flexible, and expands/contracts with freeze/thaw cycles, can fill and bond cracks/joints, has excellent traction, non-flammable, non-toxic, and effectively has no smell. For roofing, instead of re-shingling, the user can re-apply the aggregate in whatever desired color. Aggregate is re-attached to the shingles; the entire roof effectively becomes ‘one piece’, and is waterproof. Shingles will not flip up in the wind. Hail damage repairs can be targeted to specific areas without replacing the roof or its color, making repairs inexpensive, and not compromising the integrity of the ‘one piece’. The same process is used for overlaying concrete.

The product can be used on metal. Rust is a major factor, and needs food- air, water, and sodium. Treating metal with this process makes it waterproof, eliminates oxygen, and protects the surface from sodium. It stops rust growth, strengthens the metal, and is paintable. The product can be used on wood. Instead of re-staining year after year, use the overlay process. Pre-treat the wood twice, apply aggregate of a desired color, and then re-treat twice. The user will have an attractive, non-slip surface in his/her choice of colors, for years of maintenance free pleasure.

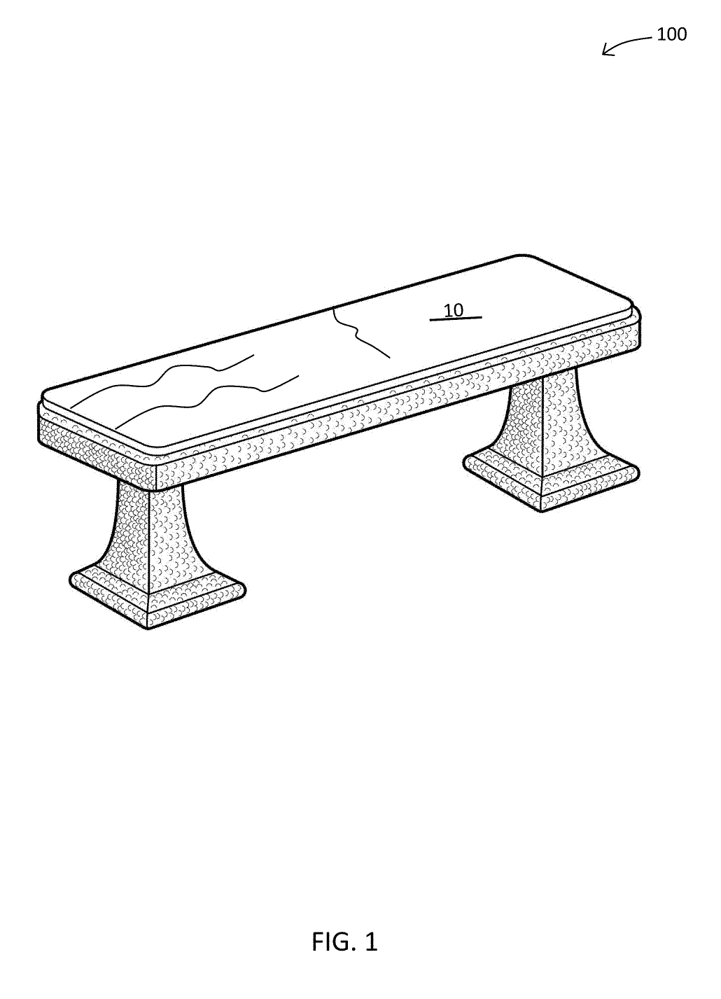

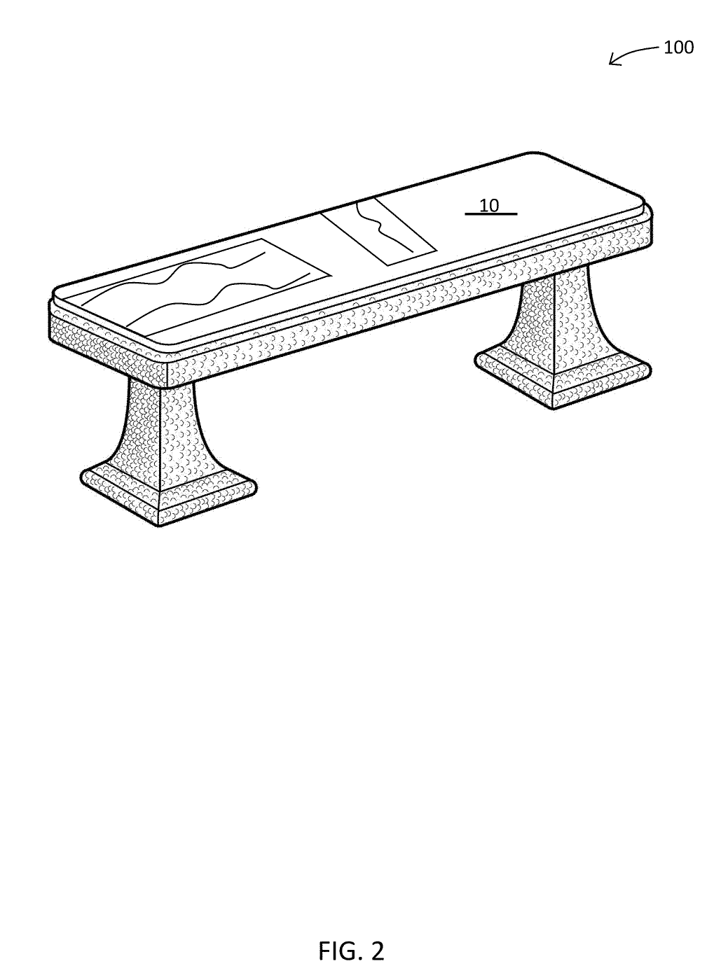

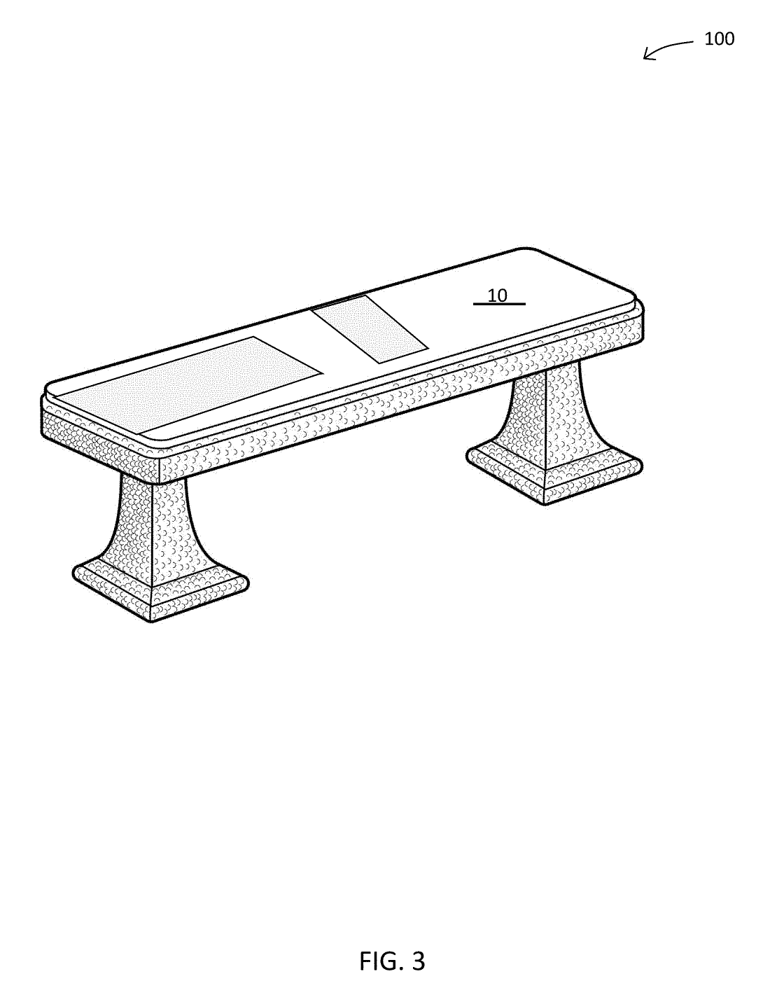

Referring now more specifically to the drawings by numerals of reference, there is shown in FIGS. 1-3, various views of a restoration system 100. As illustrated, the restoration system 100 may include a treatment composition overlay including a first-dry-part, a second-dry-part, a first-liquid-part, and a second-liquid-part. The treatment composition overlay comprises the first-dry-part, the second-dry-part, the first-liquid-part, and the second-liquid-part as an adjustable admixture. The first-dry-part comprises an acrylic based dry polymer. The second-dry-part comprises an acrylic based dry hardener. The first-liquid-part comprises polymeric resin, water, acrylic polymer, and sodium. The second-liquid-part comprises acrylic resin, water acrylic polymer, aqueous ammonia, and additives. The first-dry-part, the second-dry-part, the first-liquid-part, and the second-liquid-part are configured to be mixed to create the treatment composition overlay for restoring and preserving at least one surface 10. Other liquid or dry ingredients may be substituted or added or removed as per project application.

In certain embodiments, the treatment composition overlay may be a dry-overlay or a wet-overlay. The dry-overlay may be used for less heavy-duty items such as sidewalks. The wet-overlay may be used for heavy-duty items such as streets or driveways. The at least one surface 10 may include a plurality of items such as landscape items, windows, frames, doors, stone, tile, masonry, concrete, sandstone, roofing, wood, and flooring. The treatment composition overlay comprises a custom-color to match a color of the corresponding at least one surface 10. The treatment composition overlay may be moldable to restore sandstone, concrete and other surfaces 10. The treatment composition overlay further removes stains and restores a color of a surface in other applications. The treatment composition overlay is applied at an appropriate thickness based on a type of the at least one surface 10.

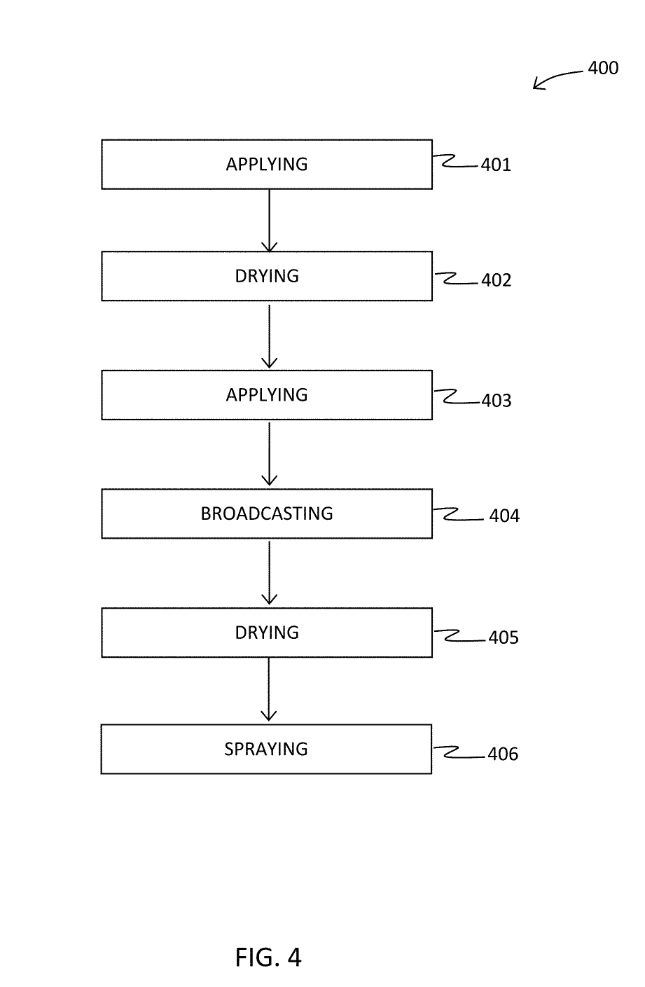

FIG. 4 is a flow diagram 450 illustrating a method treating at least one surface using the restoration system 400, according to an embodiment of the present disclosure. As illustrated, the method for treating at least one surface using the restoration system 400 may include the steps of: step one 401, applying a second-liquid-part to at least one surface 10; step two 402, drying the second-liquid-part on the at least one surface; step three 403, applying a first-liquid-part; step four 404, broadcasting dry aggregate evenly into the first-liquid-part; step five 405, drying; and step six 406, spraying the second-liquid-part.

The overlay of this method is a dry-overlay. The at least one surface 10 may include landscape items, windows, frames, doors, stone, tile, masonry, concrete, sandstone, roofing, wood, and flooring. The at least one surface 10 may be a pedestrian used (or not walked on) at least one surface 10. Factors such as temperature and moisture affect dry times and thickness of the overlay applied.

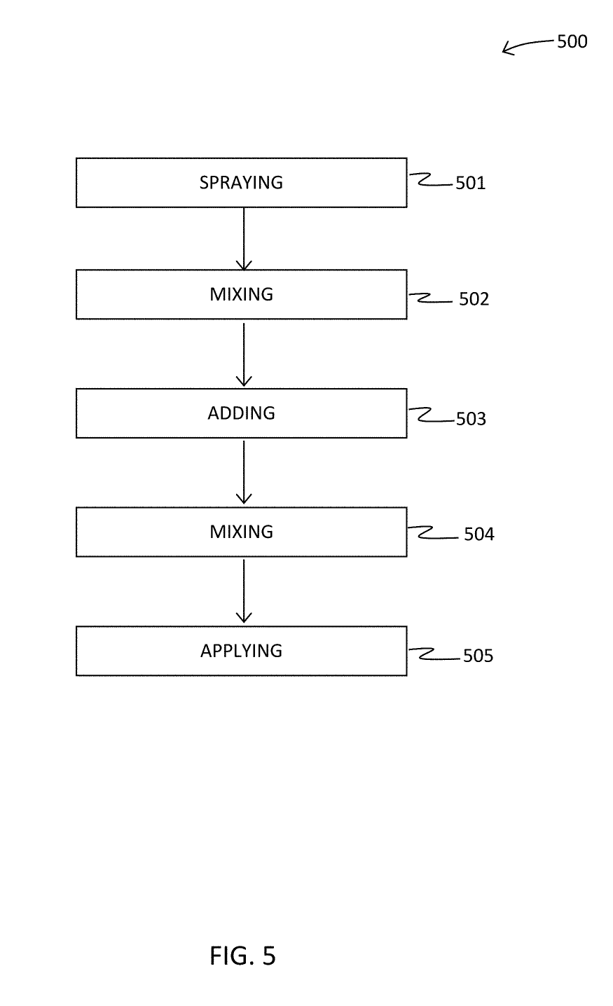

FIG. 5 is a flow diagram 550 illustrating a method for treating at least one surface using a restoration system 500, according to an embodiment of the present disclosure. As illustrated, the method for treating at least one surface using a restoration system 500 may include the steps of: step one 501, spraying at least one surface 10 with a second-liquid-part; step two 502, mixing a first-dry-part and a second-dry-part into 6 parts aggregate creating a mixture; step three 503, adding a first-liquid-part to the mixture; step four 504, mixing the mixture to a desired consistency; and step five 505, applying the mixture to the at least one surface 10.

The overlay is a wet-overlay. The wet-overlay is brushable, rollable, and trowelable. Other manipulation means may be used. Application may be approximately ⅛-inch thickness about the at least one surface 10. The thickness is adjustable (can be applied as thick as needed) to achieve a desired strength for weightload. The wet-overlay may be used in a plurality of applications including several landscape items, windows, frames, doors, stone, tile, masonry, concrete, sandstone, roofing, wood, and flooring. A first-liquid-part and the second-liquid-part when mixed are configured to bond stones together.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for restoration system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A restoration system comprising:
a treatment composition overlay including;
a first-dry-part;
a second-dry-part;
a first-liquid-part; and
a second-liquid-part;
wherein said overlay composition comprises said first-dry-part, said second-dry-part, said first-liquid-part, and said second-liquid-part as an adjustable admixture;
wherein said first-dry-part comprises an acrylic based dry polymer;
wherein said second-dry-part comprises an acrylic based dry hardener;
wherein said first-liquid-part comprises polymeric resin, water, acrylic polymer, and sodium;
wherein said second-liquid-part comprises acrylic resin, water acrylic polymer, aqueous ammonia, and additives; and
wherein said first-dry-part, said second-dry-part, said first-liquid-part, and said second-liquid-part are configured to be mixed to create said treatment composition overlay for restoring and preserving at least one surface.

2. The restoration system of claim 1, wherein said overlay is a dry-overlay.

3. The restoration system of claim 1, wherein said overlay is a wet-overlay.

4. The restoration system of claim 1, wherein said at least one surface is selected from the group consisting of landscape items, windows, frames, doors, stone, tile, masonry, concrete, sandstone, roofing, wood, and flooring.

5. The restoration system of claim 4, wherein said treatment composition overlay comprises a custom-color to match a color of said at least one surface.

6. The restoration system of claim 1, wherein said treatment composition overlay is moldable.

7. The restoration system of claim 1, wherein said treatment composition overlay removes stains.

8. The restoration system of claim 1, wherein said treatment composition overlay is applied at an appropriate thickness based on a type of said at least one surface.

9. A method treating at least one surface using said restoration system, the method comprising the steps of:
applying a second-liquid-part to at least one surface;
drying said second-liquid-part on said at least one surface;
applying a first-liquid-part;
broadcasting dry aggregate evenly into said first-liquid-part;
drying; and
spraying said second-liquid-part.

10. The restoration system of claim 9, wherein said overlay is a dry-overlay.

11. The restoration system of claim 9, wherein said at least one surface is selected from the group consisting of landscape items, windows, frames, doors, stone, tile, masonry, concrete, sandstone, roofing, wood, and flooring.

12. The restoration system of claim 9, wherein said at least one surface is a pedestrian used said at least one surface.

13. A method for treating at least one surface using a restoration system, the method comprising the steps of:
spraying at least one surface with a second-liquid-part;
mixing a first-dry-part and a second-dry-part into 6 parts aggregate creating a mixture;
adding a first-liquid-part to said mixture;
mixing said mixture to a desired consistency; and
applying said mixture to said at least one surface.

14. The restoration system of claim 13, wherein said overlay is a wet-overlay.

15. The restoration system of claim 13, wherein application is approximately ⅛-inch thickness about said at least one surface.

16. The restoration system of claim 13, wherein said thickness is adjustable.

17. The restoration system of claim 13, wherein said at least one surface is selected from the group consisting of landscape items, windows, frames, doors, stone, tile, masonry, concrete, sandstone, roofing, wood, and flooring.

18. The restoration system of claim 13, wherein a first-liquid-part and said second-liquid-part when mixed are configured to bond stones together.

19. The restoration system of claim 13, wherein said at least one surface is a vehicle-used said at least one surface.

20. The restoration system of claim 14, wherein said wet-overlay is brushable, rollable, and trowelable.
